(19) United States
(12) Patent Application Publication
(10) Pub. No.: US 2014/0223981 A1
(43) Pub. Date: Aug. 14, 2014

(54) FERTILIZERS FOR CARBON SEQUESTRATION AND ENHANCED NUTRIENT EFFICIENCY

(71) Applicants: Patrick G. Hatcher, Norfolk, VA (US); John Joseph Moriarty, Virginia Beach, VA (US)

(72) Inventors: Patrick G. Hatcher, Norfolk, VA (US); John Joseph Moriarty, Virginia Beach, VA (US)

(73) Assignees: OLD DOMINION UNIVERSITY RESEARCH FOUNDATION, Norfolk, VA (US); John Joseph Moriarty, Virginia Beach, VA (US)

(21) Appl. No.: 14/180,816

(22) Filed: Feb. 14, 2014

Related U.S. Application Data
(60) Provisional application No. 61/764,735, filed on Feb. 14, 2013.

(51) Int. Cl. C05G 3/00; C05C 9/02; C05C 9/00; C05C 11/00

(52) U.S. Cl. CPC C05G 3/0005; C05C 11/00; C05C 9/02; C05C 9/00
USPC 71/23

(57) ABSTRACT

Described herein are fertilizers for enhancing the carbon sequestration properties of soil. The fertilizers described herein include algae comprising algaenan. In one aspect, the fertilizer includes (a) one or more organic nitrogen sources, (b) one or more synthetic nitrogen sources, and (c) algae comprising algaenan. The fertilizers and fertilizer compositions release nitrogen at a predictable rate over time, which can enhance growth of plants that are fertile with the composition described herein.

### CROSS REFERENCE TO RELATED APPLICATIONS

This application claims priority upon U.S. provisional application Ser. No. 61/764,735, filed Feb. 14, 2013. This application is hereby incorporated by reference in its entirety for all of its teachings.

### BACKGROUND

Businesses, environmental groups, governmental entities, and members of the scientific community have become increasingly concerned with greenhouse gas emissions in recent years. Increasing levels of carbon dioxide are being emitted into the atmosphere as a result of the combustion of fossil fuels. Further, some current agricultural practices, such as plowing, contribute directly to the loss of carbon dioxide from soils. These increased carbon dioxide emissions contribute to a warmer climate and an increasing frequency of extreme weather conditions. While alternative fuels such as bioethanol are gaining in popularity, the processes used to produce these fuels often result in a large amount of waste material. Making use of the natural carbon sequestration properties of agricultural crops has been proposed as a way to reduce overall carbon emissions through a cap and trade system.

The use of conventional fertilizers creates an additional set of environmental concerns. Industrial nitrogen fixation is accomplished by variations on the Haber process, which require a great deal of energy input in the form of fossil fuels to maintain the high temperatures and pressures required to convert atmospheric nitrogen to ammonia. Further, ammonia-based fertilizers and their bacterial metabolites (i.e., nitrite and nitrate) are water-soluble and must be applied in high amounts at regular intervals. Heavy application of ammonia-based fertilizers results in increased levels of nitrogen runoff into groundwater, streams, and lakes, causing algae blooms and other types of eutrophication and disrupting these delicate ecosystems.

Slow-release nitrogen fertilizers such as urea formaldehyde polymers have been proposed as alternatives to water-soluble fertilizers in order to reduce harmful nitrogen releases into the environment. However, these fertilizers still require industrial nitrogen fixation and their decomposition to reduce ammonia is determined by the action of indigenous soil microbes. As such, the rate of nitrogen release is temperature dependent. While some progress has been made in the field of organic or biological slow-release nitrogen sources, industry tends to look upon such nitrogen sources as slow to respond to environmental conditions and thus as undesirable.

It would therefore be desirable to produce a fertilizer or fertilizer composition that enhanced carbon sequestration properties of soil beyond the natural capabilities of crops and other plants. It would be further desirable to reduce dependence on industrial nitrogen fixation by incorporating natural or organic sources of nitrogen into such a fertilizer. Ideally, the natural or organic sources of nitrogen would be at least partially composed of waste materials from other processes, reducing the amount of material incinerated and/or sent to landfills. Finally, the fertilizer would release at a predictable rate over time and would result in a lower amount of nitrogen runoff. The present invention accomplishes these aims.

### SUMMARY

Described herein are fertilizers for enhancing the carbon sequestration properties of soil. The fertilizers described herein include algae comprising algaenan. In one aspect, the fertilizer includes (a) one or more organic nitrogen sources, (b) one or more synthetic nitrogen sources, and (c) algae comprising algaenan. The fertilizers and fertilizer compositions release nitrogen at a predictable rate over time, which can enhance growth of plants that are fertile with the composition described herein.

The advantages of the materials, methods, and devices described herein will be set forth—in part in the description that follows—or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1 shows the average biomass per plant grown with different fertilizers containing an algaenan source.

### DETAILED DESCRIPTION

The compositions, methods, and articles described herein can be understood more readily by reference to the following detailed description. It is also to be understood that the terminology used herein is for the purpose of describing particular aspects only and is not intended to be limiting.

It must be noted that, as used in the specification and the appended claims, the singular forms “a,” “an,” and “the” include plural referents unless the context clearly dictates otherwise. Thus, for example, reference to “an organic nitrogen source” includes mixtures of two or more organic nitrogen sources.

“Optional” or “optionally” means that the subsequently described event or circumstance can or cannot occur and that the description includes instances where the event or circumstance occurs and instances where it does not. For example, the phrase “optionally includes an inorganic nitrogen source” means that the inorganic nitrogen source can or cannot be included.

As used herein, the term “about” is used to provide flexibility to a numerical range endpoint by providing that a given value may be “a little above” or “a little below” the endpoint without affecting the desired result.

As used herein, “soil” is any medium in which plants grow. Typical soils are mixtures of minerals, organic matter, and liquids. Soils may include organisms such as earthworms, roundworms, unicellular organisms, insects, spiders, and the like, or soils can optionally be sterilized before planting. Gases can be entrapped in the spaces between solid soil particles. Soils can optionally include additives such as peat moss, vermiculite, perlite, and the like.

“Sulfur-coated urea” (SCU) is a urea-containing fertilizer in particulate or granular form. Urea is released from SCU fertilizers when water penetrates through cracks or defects in the coated surface. Once the coating of an SCU fertilizer particle or granule has been breached, nitrogen release occurs quickly.

“Polymer coated urea” (PCU) is a urea-containing fertilizer wherein particles are coated with a polymer or plastic. Nitrogen release in PCU fertilizers can be delayed for weeks or months after application, and typically is slower than with SCU fertilizers. PCU fertilizers are generally costlier than SCU fertilizers, as well. PCU and SCU fertilizers can also be combined into a single fertilizer product (i.e., particles with a double coating).

“Urea formaldehyde” polymers are synthesized from urea and formaldehyde in the presence of a mild base and can be of varying lengths. In agriculture, urea formaldehyde polymers represent a source of slow-release nitrogen. Degradation of urea formaldehyde polymers is typically carried out by soil microorgansms; the activity of these microbes (and thus, the rate of nitrogen release) is temperature dependent.

“Urea-triazone nitrogen” is a heterocyclic compound with formula C₃H₇N₃O that is produced by reacting urea, formaldehyde, and ammonia. This is typically considered a slow-release form of nitrogen and can be applied in liquid form on plant leaves or can be applied directly to soil.

“Water-soluble nitrogen” refers to a nitrogen source that will dissolve completely in water. For example, urea represents a completely water-soluble nitrogen source. Water-soluble nitrogen sources are typically quick-release nitrogen sources.

“Water-insoluble nitrogen” as used herein is a fertilizer or fertilizer composition or additive in which the nitrogen is not immediately available for plant uptake. Rather, water-insoluble nitrogen is taken up slowly over time, depending on soil pH, moisture availability, temperature, and other related factors. Because of these slow-release qualities, fertilizers containing water-insoluble nitrogen have long-lasting effects, provide for sustained plant growth over a period of time, and are less likely to leach nitrogen into the environment.

“Cold water insoluble nitrogen” (abbreviated CWIN) refers to nitrogen fractions in fertilizer that are insoluble in cold water (approximately 72° F./25° C. or below).

“Hot water insoluble nitrogen” (abbreviated HWIN) refers to nitrogen fractions in fertilizer that are insoluble in hot water (approximately 212° F./100° C.).

As used herein, “activity index” is a measurement of the proportion of hot water soluble nitrogen relative to HWIN in a slow-release fertilizer. Activity index was developed in reference to urea formaldehyde fertilizers but can be applied to any slow-release fertilizer. Nitrogen from a source with a high activity index is slow to release, but releases more readily than nitrogen from a source with a low activity index. Activity index is calculated using the following equation:

AI=(CWIN−HWIN)/CWIN×100

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group, without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an illustration, a numerical range of “about 1 to about 5” should be interpreted to include not only the explicitly recited values of about 1 to about 5, but also to include individual values and sub-ranges within the indicated range. Thus, included in this numerical range are individual values such as 2, 3, and 4, the sub-ranges such as from 1-3, from 2-4, from 3-5, etc., as well as 1, 2, 3, 4, and 5, individually. The same principle applies to ranges reciting only one numerical value as a minimum or a maximum. Furthermore, such an interpretation should apply regardless of the breadth of the range or the characteristics being described.

Disclosed are materials and components that can be used for, can be used in conjunction with, can be used in preparation for, or are products of the disclosed compositions and methods. These and other materials are disclosed herein, and it is understood that when combinations, subsets, interactions, groups, etc., of these materials are disclosed, that while specific reference to each various individual and collective combination and permutation of these compounds may not be explicitly disclosed, each is specifically contemplated and described herein. For example, if a genus of algae is disclosed and discussed and a number of different synthetic nitrogen sources are discussed, each and every combination of algae genus and synthetic nitrogen source that is possible is specifically contemplated unless specifically indicated to the contrary. For example, if a class of molecules A, B, and C are disclosed, as well as a class of molecules D, E, and F, and example of a combination A+D is disclosed, then even if each is not individually recited, each is individually and collectively contemplated. Thus, in this example, each of the combinations A+E, A+F, B+D, B+E, B+F, C+D, C+E, and C+F, is specifically contemplated and should be considered disclosed from disclosure of A, B, and C; D, E, and F; and the example combination of A+D. Likewise, any subset or combination of these is also specifically contemplated and disclosed. Thus, for example, the sub-group of A+E, B+F, and C+E is specifically contemplated and should be considered from disclosure of A, B, and C; D, E, and F; and the example combination of A+D. This concept applies to all aspects of this disclosure including, but not limited to, steps in methods of making and using the disclosed compositions. Thus, if there are a variety of additional steps that can be performed with any specific embodiment or combination of embodiments of the disclosed methods, each such combination is specifically contemplated and should be considered disclosed.

### Fertilizer Composition

In one aspect, disclosed herein are fertilizers and fertilizer compositions that include algae comprising algaenan. The fertilizers described herein can include additional components including, but not limited to, a source of organic nitrogen, and a source of synthetic nitrogen. By varying the amount of algaenan source and organic nitrogen source, it is possible to produce fertilizers with specific nitrification properties that rely on lower amounts of synthetic nitrogen sources. Each component of the fertilizer and methods for preparing and using the fertilizers is described below.

Algaenan Source

The fertilizers disclosed herein incorporate an algaenan source. Algaenan is predominantly composed of highly aliphatic structures, linear or branched, connected to ester, acetal, and/or aldehyde groups. Depending upon the algal species, algaenan's structure may be more or less cross-linked by ether bridges but also by ester and acetal functional groups.

In one aspect, the algaenan source is a microorganism that synthesizes algaenan. In this aspect, the microorganism can be an alga, a protist, or a combination thereof. Algaenan is most abundant and diverse in green algae from the genera Desmodesmus, Scenedesmus, Tetraedron, Chlorella, Botryococcus and Haematococcus; thus, species of these green algae and any combination thereof can be herein. In one aspect, the algae is selected from Botryococcus braunii (race A, B, and L), a Scenedesmus species, a Desmodesmus species, a eustigmatophyte, or any combination thereof. In another aspect, the protist can be a dinoflagellate. In another aspect, the algaenan source is Desmodesmus asymmetricus. In another aspect, the algaenan source comprises a mixture of a Desmodesmus species (e.g., Desmodesmus asymmetricus) and a Scenedesmus species (e.g., Scenedesmus jovis).

In an alternative aspect, the algaenan source can be a microbial residue (spent) from the production of a biofuel. This is also referred to herein as biochar. Algae strains can be used in the production of biofuels (e.g., see U.S. Pat. No. 8,586,807 and US Publication No. 2012/0011620). In one aspect, microorganisms and microbial residues that are produced during biofuel production can be used as the algaenan source. For example, the spent algae produced in U.S. Pat. No. 8,586,807 and US Publication No. 2012/0011620, which are incorporated by reference, can be used herein. In one aspect, the algaenan source is biochar derived from mixture of a Desmodesmus species (e.g., Desmodesmus asymmetricus) and a Scenedesmus species (e.g., Scenedesmus jovis) produced during biofuel production.

The amount of algaenan present in the algaenan source can vary. In one aspect, algaenan can be present in an amount of from about 5% to about 15% by weight of the algaenan source. In this aspect, algaenan can be about 5%, about 6%, about 7%, about 8%, about 9%, about 10%, about 11%, about 12%, about 13%, about 14%, or about 15% by weight of the algaenan source.

The algaenan source can be present in an amount of from about 10% to about 80% by weight of the fertilizer composition. In this aspect, the algaenan source can be about 10% to 70%, 10% to 60%, 15% to 55%, 20% to 55%, or 25% to 50% by weight of the fertilizer composition.

Not wishing to be bound by theory, algaenan offers protection to the algaenan source organism(s). In this aspect, algaenan may form a multilayer, protective outer wall or may be a component of the source organism's cell wall. In a further aspect, the algaenan persists geologically in water, sediments, and even soils. In still another aspect, algaenan makes up a portion of the spent residue in algal biofuel production facilities. In one aspect, a portion of the biomass from algaenan-containing organisms can be oxidized in the natural environment. In this aspect, the portion of biomass that persists unaltered for at least 200 days is the algaenan. In sediments, algaenan can persist in a relatively unaltered state for millions of years.

In one aspect, the algaenan source possesses a high nitrogen content relative to other organic nitrogen sources. For example, the elemental nitrogen level in the algaenan source can be up to 10% by weight. In another aspect, the elemental nitrogen level in the algaenan source is about 1%, about 2%, about 3%, about 4%, about 5%, about 6%, about 7%, about 8%, about 9%, or about 10% by weight of the algaenan source.

The algaenan source can be produced using techniques known in the art. In the case when the algaenan source is natural algae, the algae can be grown and harvested in systems composed of mixing tanks and settling tanks. Once the algaenan source (i.e., the natural algae or biochar) has been produced, it is isolated and dried to remove residual water. The final dried product can them be pelletized, milled, extruded, or granulated to a desired particle size prior to use as a fertilizer.

Preparation of Fertilizer

The algaenan source can be admixed with one or more components typically present in fertilizers in any agricultural application. In one aspect, the algaenan source can be granulated in dry form and then mixed or blended with a commercial fertilizer. In another aspect, the algaenan source can be granulated with one or more additional fertilizer components (organic and/or synthetic nitrogen sources) to produce homogenous granules. The type of commercial fertilizer selected can vary on the application. Likewise, the amount of the algaenan source can also vary depending upon the end-use of the fertilizer.

In one aspect, in addition to the algaenan source, the fertilizer compositions described herein include one or more sources of nitrogen. In a further aspect, one or more sources of nitrogen in the fertilizer can be “natural” or “organic” sources of nitrogen. In this aspect, the one or more nitrogen sources are derived from biological material. In still another aspect, the natural or organic source of nitrogen can be manure, fish blood and bone, blood meal, bone meal, feather meal, corn gluten meal, blood meal, or any combination thereof. In a further aspect, the manure can be from poultry (e.g., from chickens or turkeys), horses, cattle, pigs, sheep, rabbits, seabirds, or a combination thereof.

In another aspect, the organic nitrogen source can be a biosolid. “Biosolids” are processed solids from wastewater treatment plants. Biosolids are typically of organic or natural origin and can be included in the group of organic nitrogen sources. The majority of nitrogen in biosolids is slowly released into the soil. Biosolids can also contain other nutrients, in addition to nitrogen.

In one aspect, the organic nitrogen source can be an exceptional quality (class A) biosolid. “Exceptional quality (class A) biosolids” are biosolids containing no detectable pathogens and that do not attract disease-carrying organisms (i.e., insects, rodents, and the like). Exceptional quality biosolids have been processed to remove liquids and have also been heated; these can be used as fertilizers without restriction. Here, the biosolids contain approximately 90% water insoluble nitrogen. Further, exceptional quality biosolids meet minimum standards set by the U.S. Environmental Protection Agency with respect to low levels of heavy metal content.

The type and amount of organic nitrogen source can vary depending upon the amount of nitrogen to be released. Not wishing to be bound by theory, decomposition of the organic nitrogen source and/or nitrification is dependent on the presence of other biological molecules, including long-chain molecules with a wide range of molecular weights. For example, biosolids contain proteins, cellulose, fat, and other carbohydrates that can affect the rate of microbial decomposition of nitrogen compounds. In one aspect, poultry manure, which contains a much lower level of water insoluble nitrogen, can be combined with a biosolid (e.g., class A biosolid) to produce a formula containing approximately 50-55% water insoluble nitrogen. In still another aspect, a combination of organic nitrogen sources can be designed to replicate the nitrogen release properties of conventional urea formaldehyde polymer mixtures.

In a further aspect, a mixture or combination of natural or organic sources of nitrogen can be used to finely control the nitrogen release properties of a fertilizer, fertilizer composition, or fertilizer additive. In this aspect, the composition of each component is unique. For example, the amount and type of proteins present in each source may vary and the nitrogen content along with those factors. Further in this aspect, other carbon-containing organic compounds such as, for example, fat, starch, and fiber may affect the timeframe for nitrification of a fertilizer.

In one aspect, the natural or organic nitrogen source is present in an amount of from 25% to 50% by weight of the fertilizer. In this aspect, the natural or organic nitrogen source makes up about 25%, about 30%, about 35%, about 40%, about 45%, or about 50% by weight of the fertilizer. Examples of commercially available organic nitrogen sources include, but are not limited to, Milorganite® (biosolids only), Earth Works® (poultry manure only), Sustane® (turkey litter only), and Nature Safe® (meals derived from animal rendering by-products of the food industry).

In another aspect, one or more sources of nitrogen in the fertilizer can be “synthetic” sources of nitrogen. In this aspect, the one or more nitrogen sources are derived from a chemical reaction. In certain aspects, the synthetic nitrogen source can be a polymer, contain carbon, and can contain urea and/or formaldehyde monomer units.

In one aspect, the synthetic nitrogen source can be polymeric and/or covalently-linked compounds that may contain carbon and/or oxygen molecules in addition to nitrogen. In an alternative aspect, the synthetic nitrogen source can be coated to control the rate of release of nitrogen into the soil. In yet another aspect, the synthetic nitrogen source can be urea, sulfur-coated urea, polymer-coated urea, methylol urea, methylolurea ether, isobutylidene diurea, urea formaldehyde, urea-triazone nitrogen, methylene diurea, dimethylene triurea, trimethylene tetraurea, tetramethylene pentaurea, pentamethylene hexaurea, related compounds, or a combination thereof. In other aspects, the synthetic nitrogen source can also contain free urea molecules and can be fast-release (quick-release), slow-release, or a combination thereof.

In one aspect, the synthetic nitrogen source is present in an amount of from 30% to 70% by weight of the fertilizer. In this aspect, the synthetic nitrogen source can be about 30% to 70%, 35% to 65%, 40% to 60%, or 40% to 50% by weight of the fertilizer.

In one aspect, the synthetic nitrogen source is urea formaldehyde and is a slow-release nitrogen source. In this aspect, the synthetic nitrogen source must be blended with other conventional (such as, for example, inorganic) nitrogen sources to provide a consistent rate of nitrogen release over time. In a further aspect, urea formaldehyde or other synthetic nitrogen sources and/or inorganic nitrogen sources can be customized with one or more organic nitrogen sources to provide a predictable and consistent nitrogen release performance.

In one aspect, the fertilizer can additionally contain an inorganic nitrogen source. “Inorganic nitrogen sources” are mineral-based and/or ionic compounds containing, for example, nitrate ions and/or ammonia ions, both of which provide nitrogen in a form available for uptake by plants or for conversion into an uptake-compatible form by soil microorganisms. Inorganic nitrogen sources are typically water-soluble and fast-release (quick-release).

In one aspect, the inorganic nitrogen source can optionally be obtained via mining or via a chemical synthesis such as, for example, the Haber process. In a further aspect, the inorganic nitrogen source can be an ionic compound. In a still further aspect, the ionic compound can be ammonium nitrate, ammonium sulfate, calcium nitrate, monammonium phosphate, diammonium phosphate, potassium nitrate, related compounds, or a combination thereof. In one aspect, the inorganic nitrogen source contains primarily water soluble nitrogen that is quickly released into the soil.

In one aspect, part or all of the nitrogen from the natural or organic nitrogen source, the synthetic nitrogen source, and/or the inorganic source can be water soluble. In another aspect, part or all of the nitrogen from any of these sources can be water insoluble nitrogen.

In another aspect, the rate of nitrogen release of one or more of the nitrogen sources in the present fertilizer compositions is fast. In a further aspect, the rate of nitrogen release of one or more of the nitrogen sources in the present fertilizer compositions is slow. In still another aspect, a combination of fast-release (quick-release) and slow-release nitrogen sources is constructed so as to provide consistent and predictable release of nitrogen over time. In this aspect, a fertilizer can contain, for example, urea, ammonium sulfate, sulfur coated urea, poultry manure, biosolids, and algaenan-producing algae. In one aspect, nitrogen is released from the fertilizer at a constant and/or predictable rate over the course of a few weeks, a month, a few months, or an entire growing season. In another aspect, the composition of the fertilizer is constructed such that nitrogen is released at key times to support plant growth and development. In this aspect, multiple organic nitrogen sources combined with an algaenan source exhibit superior performance when compared to a single organic nitrogen source. In a further aspect, modern processing methods also serve to enhance performance of the fertilizers disclosed herein.

The presence of the organic nitrogen source provides several unique advantages when combined with a synthetic nitrogen source when compared to just a synthetic nitrogen source alone. Urea formaldehyde (UF), a synthetic nitrogen source, is the standard for a “slow release fertilizer.” Table 1 below provides the molecular weight distribution of methylene ureas found in UF fertilizer.

TABLE 1
Nitrification of Methylene Urea Polymers in a Typical Ureaform

| | | Water | | | |
|---|---|---|---|---|---|
| | | Soluble | Activity | Nitrification | |
| Component | Distribution | Nitrogen | Index | % | Weeks |
| Methylene diurea | 10% | 34 | 100 | 92 | 6-8 |
| Dimethylene triurea | 15% | 25 | 98 | 90 | 8-12 |
| Trimethylene tetraurea | 40% | 16 | 60 | 80 | 10-15 |
| Tetramethylene | 25% | 10 | 35 | 50 | 12-24 |
| pentaurea | | | | | |
| Pentamethylene | 10% | 4 | 30 | 20 | 24-32 |
| hexaurea | | | | | |

By combining the algaenan source and the organic nitrogen source with the synthetic nitrogen source such as urea, it is possible to produce a fertilizer with similar nitrogen performance. The following non-limiting example demonstrates this principle. A fertilizer composition was generated using a 16-2-3 nitrogen (N)-phosphorous (P)-potassium (K) fertilizer (blend of natural and non-natural nitrogen components). The organic or natural component was 1195 pounds of organic material per ton of final fertilizer, which was composed of 13% poultry manure, 59% biosolids, and 27% algae. The nitrogen from poultry manure was approximately 50% water soluble, that from biosolids was 10% water soluble, and the water soluble nitrogen in algae was less than 10% of the total nitrogen in algae.

Not wishing to be bound by theory, poultry manure releases the majority of its nitrogen on the order of 6-12 weeks, although poultry manure contains some nitrogen fractions that persist for longer (i.e., 12-16 weeks). Water insoluble nitrogen makes up approximately 50% of nitrogen from poultry manure; most of this is cold water insoluble nitrogen. Not wishing to be bound by theory, biosolids, releases the majority of its nitrogen on the order of 10-24 weeks, although biosolids contain some nitrogen fractions that persist for longer (i.e., 24-32 weeks). Water insoluble nitrogen makes up approximately 90% of nitrogen from biosolids; most of this is hot water insoluble nitrogen. Further, the organic matter composition of algae, including algaenan and proteins, is more persistent in the environment than either poultry manure or biosolids. Distribution of the various organic nitrogen fractions and nitrification values for these fractions in this blend are provided in Table 2. The estimated values in Table 2 are consistent with those in Table 1 with respect to UF.

TABLE 2
Estimated Distribution of Organic Nitrogen in a Blend of Poultry
Manure, Biosolids, and Algae

| | | Water | | | |
|---|---|---|---|---|---|
| | | Soluble | Activity | Nitrification | |
| Fraction | Distribution | Nitrogen | Index | % | Weeks |
| Water Soluble | 15% | 34 | 100 | 92 | 6-8 |
| CWIN | 20% | 25 | 98 | 90 | 8-12 |
| Water Insoluble | 40% | 16 | 60 | 80 | 10-15 |
| HWIN | 15% | 10 | 35 | 50 | 12-24 |
| Algae | 10% | 4 | 30 | 20 | 24-32 |

Not wishing to be bound by theory, the activity of biosolids matches similarly to that of the synthetic fractions of UF and more specifically, it has a longer delivery period of activity. The poultry manure matches similarly to another UF WIN fraction that is conducive in a range that is slow but not as slow as the longest ranges of UF and biosolid fractions. Together, these two sources essentially replicate UF's range of activity. Again, the combined mixture offers extended periods of activity closely resembling that found in standard UF formulations. Lastly, the protein and organic matter composition of algae (i.e., the algaenan source) is the most persistent. Algae has the greatest benefit for both nutrient needs long term and carbon sequestration among the natural organic sources studied.

The two organic fractions (poultry manure and biosolids) of WIN are delivered to soils embodied in a complex of organic matter along with the nitrification properties of algae. This is not the case with UF. In the absence of these substances, less biochemical reactivity results and the mineralization of nitrogen to plant available form is diminished. The delivery of WIN embodied within self-contained sources of energy that gets used towards ensuring its conversion into a more available form is a more efficient approach. For example, the presence of the naturally derived beneficial microbes in the poultry manure can further enhance the fertilizers's performance.

In one aspect, a slow nitrogen release fertilizer having improved carbon sequestration properties will incorporate the ranges of ingredients shown in Table 3.

TABLE 3
Optimal Plant Growth Formula

| | Weight Percent | Pounds per Ton |
|---|---|---|
| Component | of Fertilizer | of Fertilizer |
| Synthetic nitrogen source | 40-50 | 800-1000 |
| Organic nitrogen source | 25-50 | 500-1000 |
| Algae (algaenan source) | 10-25 | 200-500 |

The fertilizers containing an algaenan source and one or more organic nitrogen sources possess enhanced nutrient efficiency properties. Here, these fertilizers minimize loss of nutrients to the environment while providing increased nutrient availability. Not wishing to be bound by theory, these fertilizers can slow the release of plant available nutrients to the soil and/or extend the time available nutrients remain in the soil.

### Applications of Fertilizers

The presence of the algaenan source in the fertilizers described herein provide numerous advantages over fertilizers that do not have the algaenan source. In one aspect, the fertilizers described herein enhance carbon sequestration by the soil. “Carbon sequestration” as used herein refers to the capture and/or long-term storage of atmospheric carbon dioxide by the soil. Removal of carbon dioxide from the atmosphere can be accomplished by plants and algae as part of the process of photosynthesis. An important environmental benefit of carbon sequestration is the removal of greenhouse gases from the atmosphere. The term “enhance” with respect to carbon sequestration is defined as the increase of carbon sequestration by a fertilizer described herein that includes the algaenan source compared to the same fertilizer that does not include the algaenan source.

Not wishing to be bound by theory, algaenan offers protection to the algaenan source organism(s). In this aspect, algaenan may form a multilayer, protective outer wall or may be a component of the source organism's cell wall. In sediments, algaenan can persist in a relatively unaltered state for millions of years. Therefore, the algaenan source can remain in the soil for extended periods of time and, thus, remove carbon dioxide from the atmosphere over a significant period of time.

In a further aspect, for a given amount of carbon dioxide removed from the environment by improved carbon sequestration (i.e., a carbon offset), carbon credits can be generated. In this aspect, these credits can be traded in order to compensate for emissions made elsewhere. In this way, an overall reduction in carbon emissions can be achieved.

Although the presence of the algaenan source can enhance the carbon sequestration properties of the fertilizer, the fertilizers that do not possess the algaenan source can also be useful in carbon sequestration. For example, when the fertilizer includes one or more organic nitrogen sources, carbon credits can be generated, which will compensate for carbon dioxide emissions made elsewhere. Thus, the organic nitrogen source can provide short- or near-term carbon sequestration, while the algaenan source (e.g., algae described herein) can provide long-term carbon sequestration due to the stability of the algaenan source.

In another aspect, another environmental benefit provided by application of the fertilizers disclosed herein is a reduced amount of fertilizer runoff. Traditional and/or fast-release fertilizers must be used in high amounts because rain and irrigation of crops dissolve and carry away much of the available nitrogen and other nutrients. This use of fertilizer is inefficient and causes pollution including contamination of ground and surface waters leading to compromised drinking water supply, eutrophication or acidification of lakes, algae blooms, and similar problems. In one aspect, use of the slow-release fertilizers disclosed herein reduces or eliminates fertilizer runoff.

In a further aspect, application of the fertilizers disclosed herein reduces reliance on traditional and/or fast-release fertilizers. In addition to the runoff problem previously discussed, traditional fertilizers require an enormous energy input to synthesize. Many traditional fertilizers are synthesized in variations on the Haber process, which operates at high temperatures and pressures in order to fix atmospheric nitrogen (i.e., convert it to ammonia) and is usually sustained by the burning of fossil fuels. In one aspect, use of the fertilizers disclosed herein reduces reliance on the Haber process and requires the input of much lower amounts of fossil fuels to achieve fertilizers with the same nutritive values for plants. Thus, in this aspect, use of the fertilizers disclosed herein can indirectly reduce carbon emissions.

In another aspect, the fertilizers disclosed herein utilize waste materials from other agricultural, industrial, and municipal processes, thus removing these materials from landfills and other waste repositories. Typically, biofuel and/or biodiesel production results in a large amount of spent material (i.e., residue) that would normally have to be discarded. Also typically, biosolids have been disposed of in landfills. In one aspect, this spent material or these biosolids can instead be used as a natural or organic nitrogen source in the fertilizers disclosed herein, thus eliminating or reducing the need to otherwise dispose of these waste materials.

In another aspect, the fertilizers described herein enhance the growth of plants growing in soil to which the fertilizer is applied. In this aspect, the fertilizer increases the nitrogen content of the soil, which can assist in plant growth since nitrogen is typically a limiting nutrient for plant growth. In one aspect, the plants are food crops including, for example, grains (i.e., wheat, corn, millet, sorghum, rye, barley, oats, rice, buckwheat, farro, quinoa, spelt, amaranth, teff, and/or triticale), fruits and vegetables, sugarcane, and legumes. In another aspect, the plants are fodder (i.e., alfalfa, Brassica species, and grasses, as well as grains and legumes listed previously). In still another aspect, the plants are sources of herbs and spices or medicinal compounds, ornamental plants, ground cover, trees and shrubs, houseplants, or other plants.

In another aspect, application of the fertilizer improves soil quality by supplying other nutrients necessary to plant growth including, but not limited to, phosphorus, potassium, secondary nutrients, and trace elements. In one aspect, the secondary nutrients include calcium, magnesium, sulfur, and combinations thereof. In another aspect, trace elements include boron, copper, iron, chloride, manganese, molybdenum, zinc, and combinations thereof.

In one aspect, enhancement of plant growth is measured by observing plant responses to the application of fertilizer. In this aspect, changes in growth response can be observed within a few days, a few weeks, a few months, or an entire growing season. In a further aspect, changes in growth response of plants can be quantitatively measured by evaluating stem length and circumference, thickness or weight of leaves, rates of plant growth over time, yield of biomass at a predetermined point in the growing season, agricultural yield, seed production, leaf color (as an indication of pigment production, for example), fruit or vegetable weight, or a combination thereof.

In one aspect, the fertilizer is applied to soil before plants are planted in the soil. In another aspect, fertilizer is applied to soil after plants are planted in the soil. In still another aspect, fertilizer is applied both before and after plants are planted in the soil. In one aspect, fertilizer can be applied multiple times in a single growing season. In a further aspect, the application of fertilizer can be accompanied by irrigation of the plants. In any of these aspects, plants can be planted as seeds, seedlings, cuttings, rhizomes, runners, grafts on rootstocks, bulbs, corms, tubers, dormant plants, or transplanted mature plants. In one aspect, the fertilizers described herein can be applied to the surface of the soil and/or intimately mixed with the soil. Not wishing to be bound by theory, the presence of the organic nitrogen source provides biodiversity to the treated soil. Here, more biochemical activity is present in the soil, where ultimately more nitrogen is delivered to the plant cultivated in the treated soil. Moreover, the population of microorganisms increases as well. Finally, the organic matter contains growth regulators such as, for examples auxins and humates, which can impart increased drought tolerance and suppression of diseases.

Throughout this application, various publications are referenced. The disclosures of these publications in their entireties are hereby incorporated by reference into this application in order to more fully describe the compounds, compositions, and methods described herein.

### EXAMPLES

The following examples are put forth so as to provide those of ordinary skill in the art with a complete disclosure and description of how the compositions and methods described and claimed herein are made and evaluated, and are intended to be purely exemplary and are not intended to limit the scope of what the inventors regard as their invention. Efforts have been made to ensure accuracy with respect to numbers (e.g., amounts, temperatures, etc.), but some errors and deviations should be accounted for. Unless indicated otherwise, parts are parts by weight, temperature is in ° C. or is at ambient temperature, and pressure is at or near atmospheric. Numerous variations and combinations of reaction conditions, e.g., component concentrations, desired solvents, solvent mixtures, temperatures, pressures, and other reaction ranges and conditions can be used to optimize the product purity and yield obtained from the described process. Only reasonable and routine experimentation will be required to optimize such process conditions.

### Example 1

### Evaluation of Fertilizer with Corn Growth

### Procedure

The experiment began with the soil sampling at a depth of 20 cm into the earth. The samples were taken from the four corners of the plot, as well as six more samples from random points inside the field. A&L Eastern Laboratories analyzed soil samples from the tract and gave recommendations for nutrient replenishment. The recommendations showed that the soil was nutrient poor and needed large amounts of nitrogen, potassium, and phosphate in order to meet the requirements for growing corn. The corn seeds used were a DEKALB Feed Corn Seed Hybrid. Information regarding the commercial fertilizer and urea can be found in Tables 1 and 2.

The mass of each fertilizer applied to specific rows can be found listed in kilograms in Table 3. The calculations to reach these numbers used the mass of nitrogen recommended for each square meter, divided by the percent of nitrogen in each fertilizer, multiplied by 30 m² per row. Since the application of fertilizer was performed twice, the numbers in the table were halved for each application. The field was divided into eight rows, each row a different type of fertilizer. Each row measured one meter wide by thirty meters long, and was further separated into sections grouping plants together in 7.5 meter lengths. These sections were added to account for soil variability in the test plot. The different applications of fertilizer to each row can also be seen in Table 3. In the first and eighth row, the seeds were planted but did not receive any fertilizer. The other six rows received commercial fertilizer, algae, or a combination of the two. The rationale behind the various ratios of normal algae to commercial fertilizer was to test for an optimal ratio of the organic and inorganic fertilizers. The seventh row contained a 1 to 4 mix of the algal char byproduct to the commercial fertilizer, added to test for differences between the byproduct and the normal algae.

The individual seeds were planted 7.5 cm apart in each section, translating to approximately one hundred seeds per section. Plants were counted every two weeks and were recorded by section. Measurements were also taken every two weeks on an alternating pattern with the counts, and the plant height was determined by taking the mean of ten plants in each section through random sampling.

Once the majority of plants reached 36 cm in height, a second application of fertilizer was spread onto the rows, completing the addition of nutrients. Geese presented a problem for recording accurate height as they ate some of the plant leaves. Effected plants were not included in the sample for height, and measures were taken to repel the geese using a fence and repellent spray. Biomass recordings were taken after the corn had grown for 90 days, the length of time required for maturation. The plants were cut at the base of the stalk and weighed by section. Taking the total mass of the plants in each section divided by the number of plants resulted in an average mass per plant, recorded in Table 4. These numbers were run through an ANOVA test to compare the different variables, excluding the 1^{st} control row of seed only. Further statistical analysis was used to compare the 1:4 Algae Char byproduct with the 1:4 Algae.

TABLE 1
Hyponex All Purpose Garden Fertilizer

| | |
|---|---|
| 10-10-10 | |
| EPA Est. No. | |
| V10340/V0/1/11:47/3 | 538-OH-2 |
| Nitrogen | 3.91% Ammonical N |
| | 6.09% Urea N |
| Phosphorous | 10% Phosphate (P₂O₅) |
| Potassium | 10% Potash (K₂O) |

TABLE 2
Southern States Cooperative, Inc. Granular Urea

| 50 lbs. bag | Fertilizer 46-0-0 |
|---|---|
| 46.00% Nitrogen | |
| Barcode | 7 56637 15985 6 |

TABLE 3
Amount of Fertilizer Applied to Each Row

| | | | Commercial | |
|---|---|---|---|---|
| | | | Fertilizer | Urea |
| | | Algae (10% | (10% N) | (46% N) |
| Row # | Description | N) (kg) | (kg) | (kg) |
| 1 | Seed Only | 0 | 0 | 0 |
| 2 | Com. Fert. | 0 | 0.760 | 0.463 |
| 3 | Algae Only | 1.311 | 0 | 0 |
| 4 | 1:1 Algae:Com Fert | 0.653 | 0.381 | 0.058 |
| 5 | 1:2 Algae:Com Fert | 0.249 | 0.499 | 0.771 |
| 6 | 1:4 Algae:Com Fert | 0.262 | 0.624 | 0.091 |
| 7 | 1:4 Algal Char | 0.375 | 0.624 | 0.091 |
| | (7.36% N) | | | |
| 8 | Seed Only | 0 | 0 | 0 |

TABLE 4
Average Mass per Plant (kg/plant)

| | Section 1 | Section 2 | Section 3 | Section 4 | Mean |
|---|---|---|---|---|---|
| Seed Only | 0.065 | 0.051 | 0.065 | 0.013 | 0.048 |
| Com. Fert. Only | 0.508 | 0.498 | 0.252 | 0.228 | 0.372 |
| Algae Only | 0.234 | 0.136 | 0.092 | 0.115 | 0.144 |
| 1:1 Algae to Fert. | 0.476 | 0.402 | 0.347 | 0.186 | 0.353 |
| 1:2 Algae to Fert. | 0.474 | 0.534 | 0.399 | 0.338 | 0.436 |
| 1:4 Algae to Fert. | 0.431 | 0.410 | 0.290 | 0.195 | 0.332 |
| 1:4 Algal Char to | 0.402 | 0.457 | 0.316 | 0.268 | 0.361 |
| Fert. | | | | | |
| Seed Only | 0.147 | 0.100 | 0.089 | 0.062 | 0.100 |

### Results

In the experiment, the biomass of the corn in each section was taken after a full period of maturation and then divided by the number of plants in that section. In Table 2, the corn with commercial fertilizer added showed the highest mass per plant (0.508 kg/plant), but also had the highest standard deviation (0.152 kg/plant). Plants fertilized with the 1:2 mix of algae to commercial fertilizer and 1:4 Mix of algal char to commercial fertilizer showed lower standard deviations (0.086 kg/plant and 0.085 kg/plant respectively), while the 1:2 Algae mix plants had a mean mass per plant of 0.436 kg/plant higher than the 0.372 kg/plant of commercial fertilizer plants. In order to test the null hypothesis that changing the type of fertilizer would have no effect on corn growth, an ANOVA test with a 0.05 level of significance was used. For the different test plots, the calculated F-value was 6.360 while the p-value was 0.0006227 for the same data, shown in Table 5. The null hypothesis was rejected since the p-value is below the 0.05 level of significance. Using a t-test, a t-value of −0.421 was calculated and a p-value of 0.690 from Table 6 and since it was greater than the 0.05 level of significance, there was no statistical difference between using algae or algal char. In addition, the research hypothesis that adding algae to commercial fertilizer would improve plant growth was supported from the statistical test as well as the raw data of higher mean masses.

TABLE 5
One-Way ANOVA Results

| Source | SS | MS | df |
|---|---|---|---|
| Factor | 0.3824 | 0.0637 | 6 |
| Error | 0.2067 | 0.0115 | 18 |

F-value: 6.3595
p-value: 0.0006227

TABLE 6
Two Sample t-test

| | 1:4 Algae to Com. | |
|---|---|---|
| | Fert. | 1:4 Algal Char to Com. Fert. |
| Mean | 0.3315 | 0.36075 |
| Standard Deviation | 0.110 | 0.085 |
| Sample Size | 4 | 4 |
| t-test results | t = −0.42077 | p = 0.68950 |

### CONCLUSION

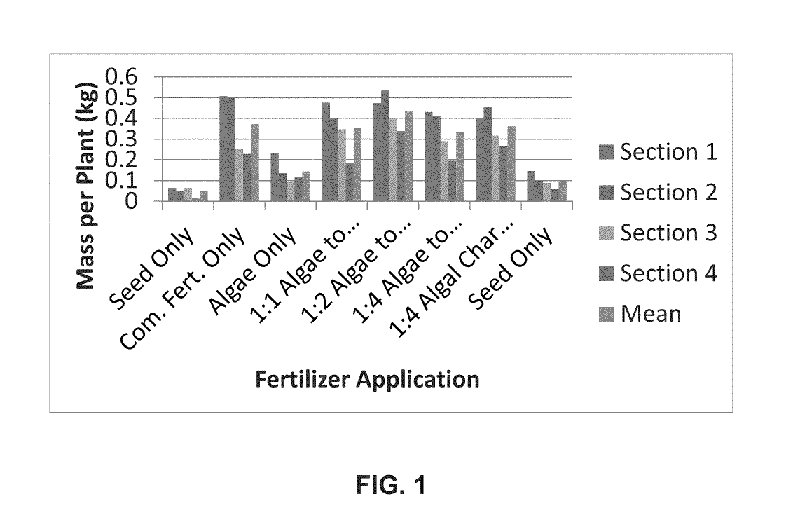

The purpose of the experiment was to test the effect of fertilizers mixed with algae on corn growth. The results are summarized in FIG. 1. In the algae and commercial fertilizer mix, an optimal ratio was achieved when one part algae and two parts commercial fertilizer were mixed to achieve the required amount of nitrogen per row. The mean difference between the commercial fertilizer and the 1:2 mix for mass per plant was 65 g per plant, which translated to a 29% increase in the total biomass produced by each stalk of corn. In order to test the entire group for variance, an ANOVA test was used, with the first control of seed only excluded due to damage from the hurricane. At a 0.05 level of significance, the F-value of 6.536 and p-value of 0.0006227 rejected the null hypothesis that changing the type of fertilizer would have no effect on corn growth. Testing also showed that the corn treated with the algae char, the byproduct of the biodiesel reaction, and fertilizer mix, was not significantly different from the pure algae to fertilizer. The research hypothesis that adding algae to commercial fertilizer was supported by the higher mean mass of 0.436 kg per plant in the 1:2 algae to fertilizer mix versus the 0.372 kg per plant mean for commercial fertilizer corn plants.

Various modifications and variations can be made to the compounds, compositions, and methods described herein. Other aspects of the compounds, compositions, and methods described herein will be apparent from consideration of the specification and practice of the compounds, compositions, and methods disclosed herein. It is intended that the specification and Examples be considered as exemplary.

What is claimed:

1. A method for enhancing the carbon sequestration properties of soil comprising adding to the soil algae comprising algaenan.

2. The method of claim 1, wherein the algae comprises a Desmodesmus strain.

3. The method of claim 1, wherein the algae comprises a Desmodesmus strain having an algaenan content of 5% to 15%.

4. The method of claim 1, wherein the algae comprises a residue from biodiesel production.

5. The method of claim 1, wherein the fertilizer comprises (1) algae comprising algaenan, (2) an organic nitrogen source selected from the group consisting of poultry manure, biosolids, or a combination thereof, and (3) a synthetic nitrogen source.

6. The method of claim 5, wherein the algae comprises a Desmodesmus strain.

7. The method of claim 5, wherein the algae comprises a Desmodesmus strain having an algaenan content of 5% to 15%.

8. The method of claim 5, wherein the algae comprises a residue from biodiesel production.

9. The method of claim 5, wherein the synthetic nitrogen source comprises urea formaldehyde.

10. The method of claim 5, wherein the synthetic nitrogen source is urea, sulfur coated urea, and ammonium sulfate.

11. The method of claim 5, wherein (1) the algae comprises a Desmodesmus strain having an algaenan content of 5% to 15%, (2) the organic nitrogen source is poultry manure and biosolids, (3) the synthetic nitrogen source is urea, sulfur coated urea, and (4) ammonium sulfate.

12. The method of claim 5, wherein the algae comprising algaenan is from 40% to 50% by weight of the fertilizer, (2) the organic nitrogen source is in the amount of 25% to 50% by weight of the fertilizer, and the synthetic nitrogen source is from 40% to 50% by weight of the fertilizer.

13. A fertilizer comprising (1) algae comprising algaenan, (2) an organic nitrogen source selected from the group consisting of poultry manure, a biosolid, or a combination thereof, and (3) a synthetic nitrogen source.

14. The fertilizer of claim 13, wherein the algae comprises a Desmodesmus strain.

15. The fertilizer of claim 13, wherein the algae comprises a Desmodesmus strain having an algaenan content of 5% to 15%.

16. The fertilizer of claim 13, wherein the algae comprises a residue from biodiesel production.

17. The fertilizer of claim 13, wherein the synthetic nitrogen comprises urea formaldehyde.

18. The fertilizer of claim 13, wherein the synthetic nitrogen source is urea, sulfur coated urea, and ammonium sulfate.

19. The fertilizer of claim 13, wherein (1) the algae comprises a Desmodesmus strain having an algaenan content of 5% to 15%, (2) the organic nitrogen source is poultry manure and biosolids, (3) the synthetic nitrogen source is urea and sulfur coated urea, and (4) ammonium sulfate.

20. The fertilizer of claim 13, wherein the algae comprising algaenan is from 40% to 50% by weight of the fertilizer, (2) the organic nitrogen source is poultry manure, biosolids, or a combination thereof in the amount of 25% to 50% by weight of the fertilizer, and the synthetic nitrogen source is from 40% to 50% by weight of the fertilizer.

21. A method for enhancing plant growth by applying a fertilizer of claim 13 to the soil.
